(19) United States
(12) Patent Application Publication
(10) Pub. No.: US 2004/0228553 A1
(43) Pub. Date: Nov. 18, 2004

(54) Axial plain bearing assembly

(75) Inventors: Clemens Simon, Starnberg (DE); Peter Feigl, Hohenrain (DE)

Correspondence Address: SUGHRUE MION, PLLC, 2100 PENNSYLVANIA AVENUE, N.W., SUITE 800, WASHINGTON, DC, 20037, US

(73) Assignee: BURGMANN AUTOMOTIVE GMBH

(21) Appl. No.: 10/843,630

(22) Filed: May 12, 2004

(30) Foreign Application Priority Data
May 13, 2003 (DE) 203 07 447.5

(51) Int. Cl. F16C 32/06; F16J 15/56; F16J 15/54; F16J 15/16

(52) U.S. Cl. 384/123

(57) ABSTRACT

An axial plain bearing assembly includes a thrust ring provided for common rotation with a rotary component, and a counter ring provided for mounting non-rotationally on a stationary component. The thrust and counter rings comprise bearing surfaces facing each other, between which a friction-minimizing oil film can be formed during operation. The thrust ring further comprises a radial seal face on an end face thereof remote from the counter ring for cooperating with a radial seal face of a non-rotational seal ring of a mechanical face seal assembly for forming a seal between said thrust and non-rotational seal rings. Accordingly the thrust ring is multi-functional in that it provides for an axial support of the rotary component and simultaneously acts as a rotating seal ring of a mechanical face seal assembly.

The following disclosure is based on German utility model application No. 203 07 447.5, filed on May 13, 2003 which is incorporated into this application by reference.

### FIELD OF AND BACKGROUND OF THE INVENTION

The present invention relates to an axial plain bearing assembly and in particular, to an axial plain bearing assembly suitable for the axial support of the drive shaft of an combustion air-charge compressor for use in internal combustion engines.

For the axial support and sealing of the drive shaft of a turbo-mechanically driven centrifugal or screw-type compressor or a turbo compressor having an exhaust-gas driven turbine, the special operating conditions of such aggregates require appropriate attention. For instance the drive shafts generally have a very small diameter that is frequently substantially less than 40 mm, and, at the same time, these shafts are rotated at very high rotational speeds of e.g. 10⁵ min⁻¹ and more. Hitherto, the functions of “axial support” and “sealing” of the drive shaft was taken into account by separate structural measures.

The seal of such compressors can be subjected to both over pressure and low pressure conditions prevailing in the interior of the compressor casing. Thereby it should be ensured that the gaseous medium requiring sealing, which is usually air, be kept free as far as possible of non-gaseous components such as oil particles since oily residues would otherwise enter the combustion chamber of an internal combustion engine thereby having an environmental impact (the production of plumes of smoke from the exhaust) apart from affecting the operational behaviour of the internal combustion engine. Hitherto, labyrinth seals or a sealing effect produced by means of piston rings were mostly used, both of which are associated with a relatively high degree of leakage. Also mechanical face seal assemblies (EP-A-1 054 196) have already been installed because of their substantially smaller degree of leakage, whereby care must be taken to prevent dry-running.

Plain bearings are generally preferred for the radial and axial support of the drive shaft.

The separate structural measures needed for the sealing and bearing functions involve an increase in the structural parts and assembly costs for fulfilling the functions “support” and “sealing”, whereby charge compressors of the present type are typically mass-produced and should be suitable for automatic handling in motor vehicle production lines. This requirement can be taken into account all the more easily, the smaller the number of parts that have to be handled and assembled.

### OBJECTS OF THE INVENTION

An object of the present invention is to provide an improved axial plain bearing assembly. A specific object of the present invention is to provide an axial plain bearing assembly for optimizing the functions “axial support” and “sealing” of a shaft, in particular the driving shaft of a charge compressor, in regard to the number of parts required for performing both of these functions.

### SUMMARY OF THE INVENTION

These and other objects are solved in accordance with the present invention by an axial plain bearing assembly including a thrust ring provided for common rotation with a rotary component, and a counter ring provided for mounting non-rotationally on a stationary component, said thrust and counter rings comprise bearing faces facing each other, said thrust ring further comprising a radial seal face on an end face thereof remote from the counter ring for cooperating with a radial seal face of a non-rotational seal ring of a mechanical face seal assembly for sealing said rotary and stationary components against each other.

The axial plain bearing assembly according to the present invention not only functions as an axial support of the drive shaft that is particularly effective at high to very high rotational speeds, but, at the same time, it provides the possibility of being extended or expanded into a highly effective mechanical face seal. The means required for this purpose consist essentially in equipping the rotary thrust ring of the axial plain bearing assembly with a seal face on an end face opposite to that having a conventional bearing surface. The thrust ring thereby takes on the function of a rotary seal ring in a mechanical face seal assembly whilst this simultaneously results in a corresponding saving in components. A further advantage is that the assembly of the components for axially supporting a shaft, and especially the drive shaft of a compressor, is simplified since there is only a single assembly step for obtaining the two functions “axial support” and “sealing” which hitherto required different steps. If desired, the multi-function thrust ring may be an integral part of a shaft bushing or may be provided pre-assembled thereon. The structure consisting of the seal, the bearing and the shaft bushing may be provided as a pre-assembled unit and inserted into a boring of a casing, e.g. a compressor casing, which has to be sealed, in an assembly-friendly manner. Part-by-part assembly at the point of use can likewise be effected in problem-free manner. A further advantage arising from the design of the thrust ring as a multi-function component is that the labour intensive grinding processes required for providing the bearing and seal faces on the thrust ring can be carried out, if necessary without re-clamping, on one and the same machine tool. Further advantages and effects become apparent from the following description of a preferred embodiment of the invention.

### BRIEF DESCRIPTION OF THE DRAWING

The invention will be explained in more detail hereinafter with reference to the drawing showing an embodiment thereof. In the drawing:

FIG. 1 is a longitudinal sectional view of an axial plain bearing assembly according to the invention installed in a compressor casing, and

FIG. 2 is a view of the seal face of a thrust ring of the axial plain bearing assembly according to the invention.

### DETAILED DESCRIPTION OF A PREFERRED EMBODIMENT

A preferred embodiment of the invention will now be explained in more detail with reference to the drawing.

Although the invention is described hereinafter in connection with the axial support and sealing of the drive shaft of a charge compressor of internal combustion engines, it should be understood that the invention is not limited to this field of application. Rathermore, the invention could also be used to advantage whenever a shaft of comparatively small diameter that is driven at a high rotational speed needs to be axially supported in friction-minimizing manner and sealed with respect to a casing and the medium requiring sealing is a gas such as air,

The axial plain bearing assembly according to the invention comprises an axial bearing portion serving as a axial plain bearing and a sealing portion serving as a mechanical face seal. The mechanical face it is mounted in a passage boring in a compressor casing 1, through which a shaft 2 (indicated schematically in the drawing) extends. The mechanical face seal comprises a seal ring 3 which is held non-rotationally but is axially moveable and disposed co-axial relative to the shaft 2, and a ring 4 which is arranged on the shaft 2 for common rotation therewith and which, according to the invention, is in the form of a thrust ring of the axial bearing portion. The rings 3, 4 have essentially radial seal faces 5, 6 facing each other. If desired, direction-of-rotation dependent, gas-pumping structures or grooves 7 are formed in at least one of the seal faces 5, 6, preferably in the seal face 6 of the thrust ring 4, using known techniques such as grinding, lasers or stamping, in order to pump a gas between the seal faces 5, 6 and develop a pressure when the shaft 2 rotates. As a consequence thereof, a gas cushion will be formed between the seal faces 5, 6 for separating the seal faces 5, 6 from each other in order to seal a space or zone A peripherally inward of the seal faces 5, 6 with respect to a space or zone B peripherally outward thereof. Such gas-pumping grooves 7 are known to the skilled person. In regard to the specific details thereof, including suitable designs of the gas-pumping grooves, reference may be made to page 16 et seq of BURGMANN, Gasgeschmierte Gleitringdichtungen, self published, 1997, ISBN 3-929682-15-X.

The non-rotational seal ring 3 is accommodated in a mounting casing 8 mounted son the compressor housing 1 in not-illustrated manner, and it is sealed there against by a secondary seal 9 in the form of an O-ring. In regard to the specific details of an O-ring secondary seal formed as an O-ring. For further details of an O-ring type secondary seal including materials appropriate therefor, and alternative forms of secondary seals, reference may be made to pages 161, 272-273 of BURGMANN, ABC der Gleitringdichtung, self-published, 1988.

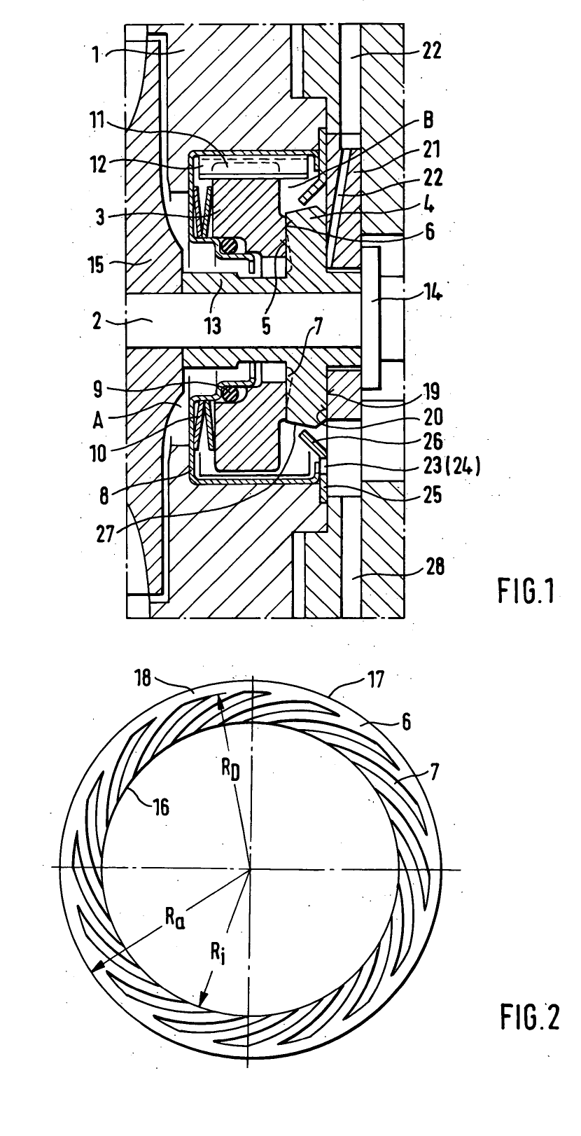

Furthermore, a spring biasing device 10 that may take the form of one or more wave springs is effective between the mounting casing 8 and the non-rotational seal ring 3, as shown in FIG. 1. The spring biasing device 10 causes the non-rotational seal ring 3 to be pressed against the thrust ring 4 rotating with the shaft 2 by a suitable bias force so that the seal faces 5, 6, of the rings 3, 4 are held together in sealing engagement with each other when the shaft 2 is stationary. In the outer periphery of the non-rotational seal ring 3, there is an axially extending groove 11 (a plurality of such grooves, distributed peripherally, could also be provided), into which projects a coupling finger 12 that protrudes radially from the mounting casing 8 towards the seal ring 3. The non-rotational seal ring 3 is thereby prevented from rotating relative to the mounting casing 8 but can move axially relative thereto.

The rotary thrust ring 4 may be mounted on the shaft 2 in any appropriate manner for the purposes of rotating in common therewith. In the present embodiment, it is an integral part of a bushing 13 which is seated on the shaft 2 and is clamped axially between a shoulder 14 of the shaft and a compressor impeller 15 mounted on the shaft 2 so that the rotation of the shaft 2 can be transferred to the thrust ring 4 without slippage. The thrust ring 4 could also be in the form of a separate component mounted on the shaft 2 or on a shaft bushing.

The preferred materials for the thrust ring 4 are high tensile materials such as suitable steel materials with or without a coating on the seal face side. For the purposes of minimizing wear, the stationary seal ring 3 preferably consists of tribologically effective materials such as a suitable carbon material, and it may, if desired, be impregnated with antimony at the seal face side using known techniques.

A large number of equally spaced, peripherally distributed gas-pumping grooves 7 are formed in the seal face 6 of the thrust ring 4. Each gas-pumping groove 7 is curved in the manner of a plough blade and extends from the inner periphery 16 of radius Rᵢ of the seal face 6 up to a radial radius R_{D} of the seal face 6 that is radially spaced from the outer periphery 17 thereof having the radius Rₐ, thereby leaving a dam portion 18 of radius R_{D} near the outer periphery 17 which is free of gas-pumping grooves 7.

A ratio of the surface area F_{GFA} covered by the gas-pumping grooves 7 to the total surface area F_{G} of the seal face 6 is preferably such that direct contact between the seal faces 5, 6 is avoided both in normal operation as well as when starting and during stoppage of the shaft 2 even in the case of very small shaft diameters of e.g. 8 to 25 mm, this being done by forming a sealing gas cushion therebetween with the aid of the gas-pumping grooves 7. It has been established that these effects are obtained if certain factors for the surface area ratio F_{GFA}/F_{G} are adhered to, and in particular, the surface area ratio should lie in the range between 0.35 and 0.65, preferably 0.4 and 0.6. Furthermore, the radial dimensions (Rₐ−Rᵢ) of the seal face 6 should not fall below a minimum amount whilst the radial dimensions (Rₐ−R_{D}) of the dam portion 18 should be kept to a minimum. As an example, sixteen gas-pumping grooves 7 having plough-blade-like leading and lagging edges may be provided around the periphery of the seal face 6.

It has also been established that particularly advantageous operational properties of the sealing portion are obtained if a load ratio k, defined as the ratio of an effective surface area of the seal portion hydraulically loaded by the pressure of the medium being sealed to the surface area of the seal face, is in a specific range k=0.5 to 1.2.

For further details in regard to suitable radial dimensions (Rₐ−Rᵢ) for the seal face 6 and radial dimensions (Rₐ−R_{D}) for the dam portion 18, reference can be made to EP-A-1 054 196.

The reason why the gas-pumping grooves 7 should preferably extend from the inner periphery 16 of the seal face 6 is that the medium requiring sealing in the zone A is practically free of non-gaseous constituents e.g. oil particles which could have detrimental effects upon the operational behaviour of the sealing portion if they were to enter the region between the seal faces 5, 6. By contrast, although the number of non-gaseous constituents e.g. oil particles in the gaseous medium on the atmospheric side is very small e.g. in the air in the space B, it is not negligible as will be discussed in more detail hereinafter. The emergence of the gas-pumping grooves 7 at the inner periphery of the seal face 6 ensures that there will be a leakage current of the medium being sealed from the space A towards the space B and thereby effectively prevents non-gaseous constituents infiltrating into space A from space B.

As is shown in FIG. 1 furthermore, the end face of the thrust ring 4 remote from the seal face 6 thereof is provided with an essentially radially aligned bearing surface 19 which cooperates with an opposing parallel bearing surface 20 of a counter ring 21 of the axial bearing portion that is mounted in relatively non-rotational manner on the casing 1 in order to form an axial plain bearing. When the axial plain bearing assembly is operative, an oil film 20 is formed between the bearing surfaces 19, 20 thereby enabling a wear-minimized relative motion between the bearing surfaces 19, 20 in a manner known in the field of axial plain bearings.

The formation of an oil film can be enhanced by feeding a bearing oil into the area between the bearing surfaces 19, 20 through an oil supply passage 22 which preferably opens at or close to the inner periphery of the bearing surface 20 of the counter ring 21. When the axial plain bearing assembly is operative, the bearing oil is forced to move from the inner to the outer periphery of the bearing surfaces 19, 20 due to the effect of the centrifugal forces prevailing. The bearing oil is preferably supplied through one or more passages 22 that penetrate the counter ring 21, at a slightly excessive pressure of e.g. 1 to 2 bar, and it leaves the bearing surfaces 19, 20 at the outer periphery of the thrust ring 4 in an essentially pressure-free state. The bearing oil may be the operating oil (engine oil) of an internal combustion engine; however it could also be provided from a separate oil-supply source.

The counter ring 21 preferably consists of a suitable bearing material such as bronze. The bearing surfaces 19, 20 are polished in appropriate manner. The bearing surface 19 of the thrust ring 4 is preferably cross-ground for improving the running properties with respect to the counter ring 21.

An oil retaining device 23 is provided for preventing the bearing oil emerging from the outer periphery of the bearing surfaces 19, 20 from being spun unhindered into the space B in order to prevent the space B from being excessively loaded with particles of bearing oil. Although other devices of this type could be provided, the preferred oil retaining device 23 shown in the drawing comprises a bent sheet 24 which is fixed to the casing 1 or counter ring 21 in appropriate manner e.g. by means of a radial arm 25 which might be screwed thereto, and which comprises an angled arm 26 that surrounds or covers in roof-like manner the point at which the bearing oil emerges from the outer periphery of the bearing surfaces 19, 20 as well as at least a part of the outer periphery of the thrust ring 4, said angled arm being radially spaced outwardly thereof. The bearing oil ejected essentially radially from the bearing surfaces 19, 20 therefore strikes the angled arm 26 of the bent sheet 24 and is fed back inwardly so that only a small portion of the bearing oil, if any, can enter the area near the seal faces 5, 6 of the sealing portion.

Furthermore, for the purposes of improving the oil retention effect, the cross-section of the outer periphery of the thrust ring 4 may, as shown, have a pitched-roof-like configuration, as is indicated by 27, so that a radially outwardly pointing spraying edge is formed, thus further constricting the access of the bearing oil to the axial plain bearing surfaces 5, 6.

The bearing oil emerging from the bearing surfaces 19, 20 and prevented from spreading in the space B by the oil retaining device 23 can accumulate at a lower spreading within space B by means of the oil retaining device 23 can accumulate at a lower location or in a tank (not shown) of the axial plain bearing assembly and be fed back from there to the exterior through an oil discharge passage 28, e.g. to the engine compartment of the internal combustion engine.

In place of the oil retaining device described and shown in FIG. 1, an oil retaining device which is based on centrifugal effect such as that described in EP-A-1 054 196 could also be envisaged, so that reference thereto can be made.

Although the invention has been described hereinabove on the basis of an embodiment in which the gas-pumping grooves extend from the inner periphery of the seal face, a reversal of the situation could also be envisaged should there be no fear of access of non-gaseous constituents from space B into space A through the seal gap. Furthermore, the gas-pumping grooves may be formed in the non-rotational seal ring instead of the thrust ring, or they could also be formed in both rings if required.

The above description of a preferred embodiment has been given by way of example. From the disclosure given, those skilled in the art will not only understand the present invention and the attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. An axial plain bearing assembly including a thrust ring provided for common rotation with a rotary component, and a counter ring provided for mounting non-rotationally on a stationary component, said thrust and counter rings comprise bearing faces facing each other, said thrust ring further comprising a radial seal face on an end face thereof remote from the counter ring for cooperating with a radial seal face of a non-rotational seal ring of a mechanical face seal assembly for sealing said rotary and stationary components against each other.

2. The axial plain bearing assembly according to claim 1, wherein the counter ring comprises at least one passage opening at or close to the radially inner area of the bearing surface of the counter ring for supplying bearing oil to the bearing surfaces.

3. The axial plain bearing assembly according to claim 1, further including a device for removing bearing oil from an area peripherally outward of the bearing surfaces.

4. The axial plain bearing assembly according to claim 1, further including an oil retaining device encompassing the outer periphery of the bearing surfaces.

5. The axial plain bearing assembly according to claim 1, wherein a plurality of peripherally spaced gas-pumping grooves are formed in at least one of the radial seal faces of the thrust and the non-rotational seal rings, said gas-pumping grooves extending from one periphery of said one seal face towards the other periphery thereof and ending at a radial distance from the other periphery.

6. The axial plain bearing assembly according to claim 5, wherein said one seal face has a surface area ratio F_{GFA}/F_{G} within a range of between 0.35 and 0.65, preferably 0.4 and 0.6, in which: F_{GFA}=the total surface area of the gas-pumping grooves projected onto the seal face, F_{G}=the total surface area of the seal face.

7. The axial plain bearing assembly according to claim 5, wherein a load ratio k, defined as the ratio of an effective surface area F_{H} of the face seal assembly hydraulically loaded by the pressure of the medium being sealed to the surface area F_{G} of the seal face is in a range of between 0.5 and 1.2.

8. The axial plain bearing assembly according to claim 5, wherein the gas-pumping grooves are provided on the thrust ring.

9. The axial plain bearing assembly according to claim 1, wherein the thrust ring is made of a steel material.

10. The axial plain bearing assembly according to claim 1, wherein the counter ring is made of a bearing material, in particular bronze.
